(19) United States
(12) Patent Application Publication
(10) Pub. No.: US 2026/0252431 A1
(43) Pub. Date: Aug. 27, 2026

(54) SYSTEMS AND METHODS FOR REAL-TIME UPLINK AND DOWNLINK AUDIO ABNORMALITY DETECTION

(71) Applicant: Agora Lab, Inc., Santa Clara, CA (US)

(72) Inventors: Zeyuan Wang, Shanghai (CN); Sen Li, Shanghai (CN); Ruofei Chen, Shanghai (CN)

(21) Appl. No.: 19/062,924

(22) Filed: Feb. 25, 2025

(51) Int. Cl. G06F 11/07; G06F 3/16; H04W 76/28

(52) U.S. Cl. CPC G06F 11/079; G06F 3/162; G06F 11/0709; H04W 76/28

(57) ABSTRACT

Systems and methods for real-time uplink and downlink audio abnormality detection are provided. In some embodiments, the methods and systems for real time uplink and downlink audio abnormality detection includes, at the uplink device, diagnosing audio issues at each major stage of an audio uplink pipeline in an ordered fashion and at the downlink device, diagnosing the audio issues by combining abnormality monitoring from packet handling and decoding. Diagnosing audio issues triggers three independent check paths, which include a device operation check, an audio signal flow check and a network transmission check. The diagnosis results in a root cause of the audio issues being discovered. This root cause may be used to supply a user with information to fix the audio issue.

### BACKGROUND

The present invention relates in general to the field of audio processing, and more specifically to methods, computer programs and systems for real-time uplink and downlink audio abnormality detection. Generally, when recording, transmitting and playing audio signals, a front-end (uplink) device records and processes the audio signal. Audio processing includes generally at least some degree of acoustic echo cancellation (AEC), adaptive noise suppression (ANS) and automatic gain control (AGC). The processed signal is then encoded and transmitted to the end (downlink) device. At the downlink device the audio signal may be decoded and buffered. The resulting decoded signal may be played via a speaker.

This process is not without flaws and abnormalities and errors may be introduced into the audio at various stages of the process. For example, audio issues such as not recording, not playing back and other audio glitches, can occur on either the uplink sender side or the downlink receiver side, or both. In practice, audio issue diagnosis is best performed on-device as the detailed operational information of the device is more readily available and ascertained. Remote diagnosis of the audio issue relies upon data that is reported to a backend server. This reported data may be incomplete or otherwise be missing critical device operational data. Additionally, there is generally coarser time resolution of the data and a larger response delay when resolving issues remotely as opposed to on-device diagnosis.

For some use cases, this delayed and potentially less accurate diagnosis may be acceptable. However, for use cases where the consumer is less tolerant of audio issues, such as for online education, business communications and the like, the ability to more rapidly and accurately diagnose the audio issue and provide information that may be utilized to fix, or provide a work around, to the issue is preferable.

Given that there is great value in identifying audio issues in a rapid and accurate manner, real-time uplink and downlink audio anomaly detection is provided.

### SUMMARY

The present systems and methods relate to audio processing, and particularly to real time uplink and downlink audio abnormality detection. Such systems and methods enable improved and efficient identification of issues with an audio system to allow for fixes of the audio issue and/or providing information regarding the audio issue that enables a work-around.

In some embodiments, the methods and systems for real time uplink and downlink audio abnormality detection includes, at the uplink device, diagnosing audio issues at each major stage of an audio uplink pipeline in an ordered fashion and at the downlink device, diagnosing the audio issues by combining abnormality monitoring from packet handling and decoding. Diagnosing the audio issues triggers three independent check paths, which include a device operation check, an audio signal flow check and a network transmission check. The device operation check includes a focus on device operational status, such as no recording frequency, audio device interruption by third party applications, no recording permissions, user muting of the microphone, user muting of the speaker, and the like. Conversely, audio signal flow check includes a focus on audio volume abnormalities such as frozen volume, no recording volume, no playback volume and the like. Lastly, network transmission check includes a focus on packet transmission abnormalities such as disconnect events, excessive packet loss and the like. The diagnosis results in a root cause of the audio issues being discovered. This root cause may be used to supply a user with information to fix the audio issue.

The uplink audio abnormality detection includes an Audio Device Manager (ADM) recording frequency check, a muted microphone check, a near-in audio signal frozen check, a near-out audio signal frozen check, a no recorded signal volume check, a muted local check (e.g., a check for if the audio stream is not being sent even when the uplink audio processing modules are operating normally), and a low send bitrate check. The near-out audio signal frozen check includes a Pitch Smoother (PS) enabled check. The PS is a particular audio processing module that may set the audio signal volume to zero as an expected algorithmic behavior. The near-out audio signal frozen check may incorporate checks for expected algorithmic behaviors of the various audio processing modules. The low send bitrate check includes a Discontinuous Transmission (DTX) mode enabled and transmitting bitrate above zero check.

The downlink audio abnormality detection includes an ADM playback frequency check, a muted remote peers check, a no playback signal volume check, a speaker muted check, a no peers check, a peer analyzer check and a far-in audio signal frozen check. The peer analyzer check includes performing a peer state analysis.

For each of the remote audio peers, the peer analyzer check includes a check if the receiving bitrate is zero and audio loss rate is zero, a check in the receiving bitrate is greater than zero and the audio loss rate is 100%, and a check if the receiving bitrate is zero and the audio loss rate is greater than a threshold. In some cases, the threshold is 20%.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1A is an example block diagrams of a system for traditional audio processing, in accordance with some embodiment;

FIG. 1B is an example block diagram for a system where uplink and downlink audio abnormality detection is occurring in real time, in accordance with some embodiments;

FIGS. 2A and 2B are a flow diagram for an example process of uplink audio abnormality detection, in accordance with some embodiments;

FIGS. 3A and 3B are a flow diagram for an example process of a downlink audio abnormalities detection, in accordance with some embodiments;

FIG. 4 is a flow diagram for an example sub-process of downlink audio abnormality detection for each of the remote audio peers, in accordance with some embodiments;

FIG. 5 is a flow diagram for an example logical process of anomaly detection; in accordance with some embodiments; and

FIGS. 6A and 6B are illustrations of computer systems capable of implementing the audio abnormality detection, in accordance with some embodiments.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

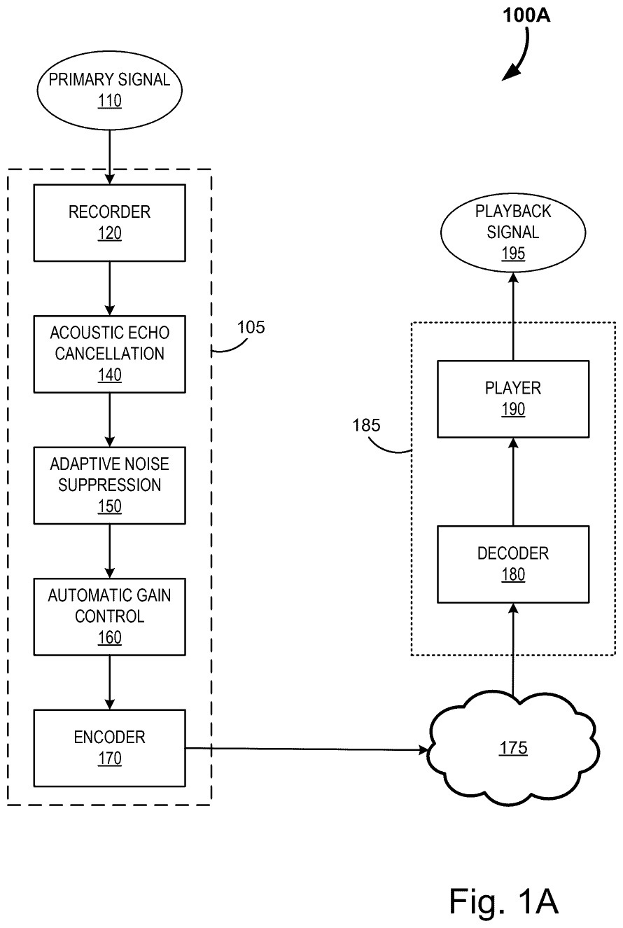

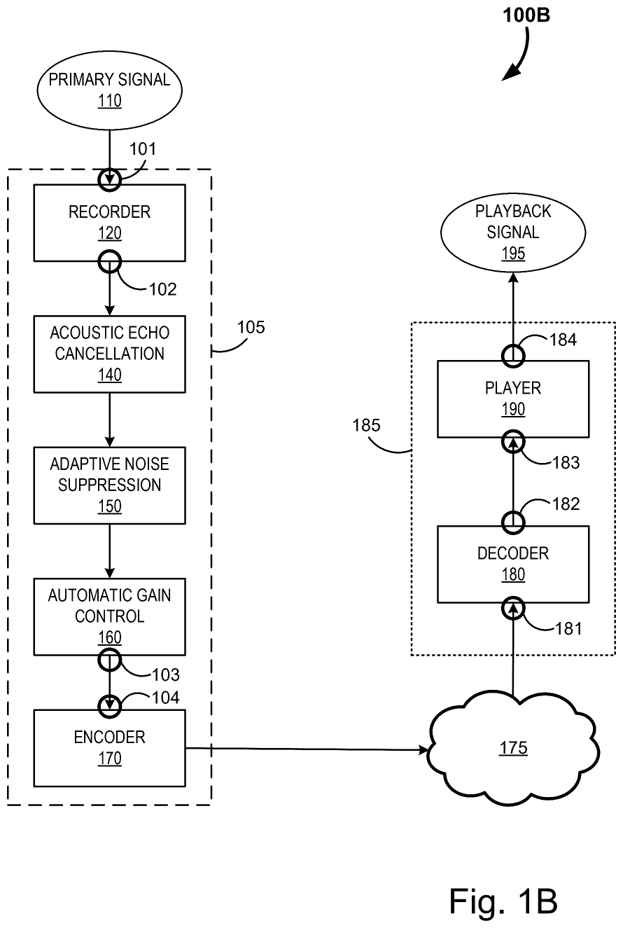

The present invention relates to systems and methods for real time uplink and downlink audio abnormality detection. As noted before, the ability to detect the issue with audio quality is best performed on the device in use as there is more device information available to accurately diagnose the issue. To facilitate discussions, FIG. 1A provides a detailed view of an audio system where an uplink device 105 receives and records an audio signal and transmits it to a downlink device 185 for playback to an end user. In this example illustration, the primary/near field audio signal 110 is received at a recorder 120 of a frontend/uplink device (represented by the dotted line box 105). The recorder 120 includes a microphone or other transducer device. The front end recording may be provided to an acoustic echo cancellation (AEC) module 140 for echo cancellation along with a far-end reference signal (if present) which is what has been played previously via a loudspeaker of the device. The AEC module 140 subtracts out the time delayed far-end reference signal from the near-end audio signal 110 to remove echo artifacts. The adjusted signal is then provided to a module that analyzes the ambient noise.

This adaptive noise suppression (ANS) module 150 adjusts the signal further to remove ambient noise from the signal. The further adjusted signal is provided to an automatic gain controller (AGC) 160 which is a circuit that is a closed-loop feedback regulating circuit that adjusts the relative amplification of the signal to ensure a consistent volume level. This results in a clean, consistent audio signal that may be encoded and compressed at an encoder 170 and then transmitted via an antenna and transmission circuitry (not illustrated).

The transmission may be via local Wi-Fi, cellular, via the internet, or by some combination of the above. This transmission via the cloud 175 results in the signal being routed to a decoder 180 located in an end/downlink device 185. A player 190 (optional) may then play the decoded signal 195. Additionally, or alternatively, the decoded signal may be subject to further processing, such as speech recognition and other Machine Learning (ML) analysis.

FIG. 1B provides the same system as provided in FIG. 1A, but with a series of anomaly detection checks, illustrated as circles in the audio processing pathway. These audio anomaly detection checks include checks at each major stage of the audio uplink pipeline in an ordered fashion in order to capture the abnormality at the most relevant location. The downlink on-device diagnosis is conducted by combining the abnormality monitoring in packet handling and the decoding and playback aspects. The system may also support the analysis of multiple audio streams.

Particularly, abnormality detection occurs at the point of recording (at 101), and subsequently at the point the recorded audio is converted into a signal for audio processing (at 102). Also in the uplink device, after audio processing (at 103) the signal may be analyzed, as well as at encoding (at 104). Transmission of the signal may be checked at the downlink device (at 181). The signal fidelity after decoding may also be analyzed (at 182) as is the player signal (at 183) and the player device itself (at 184).

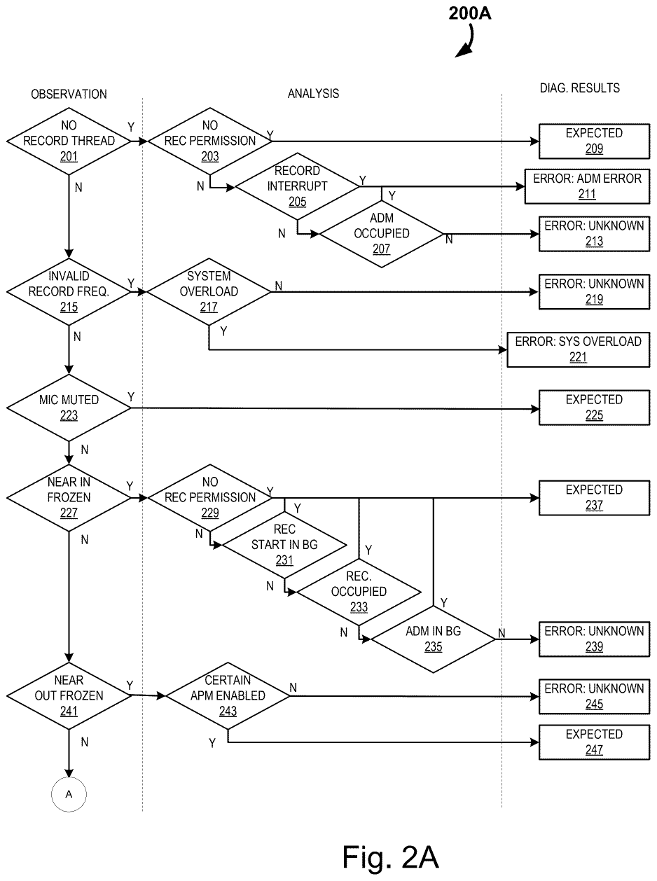

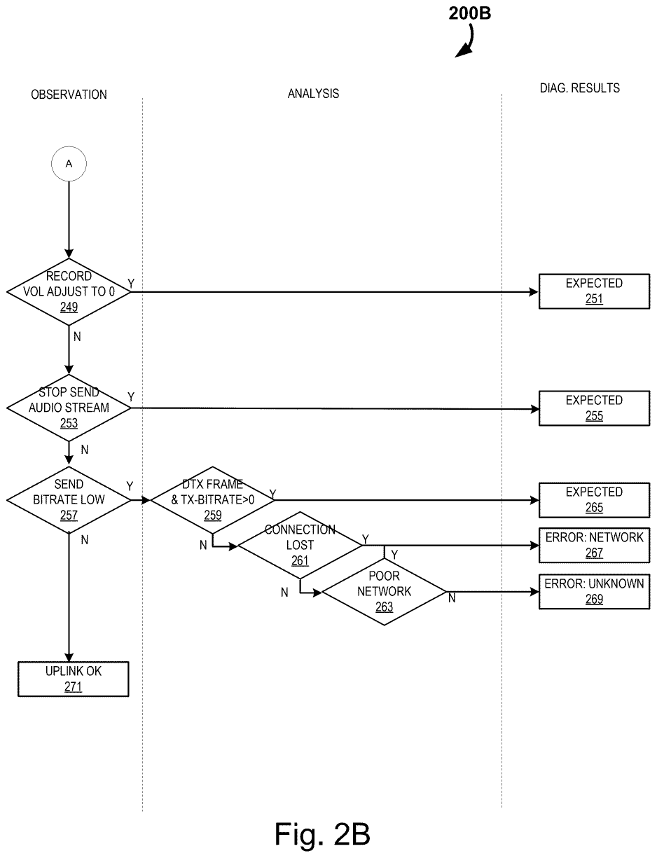

This uplink and downlink diagnosis triggers three types of check paths: a device operation check, an audio signal flow check and a network transmission check. The device operation check includes a focus on device operational status, such as no recording frequency, no playback frequency, audio device interruption by third party applications, no recording permissions, user muting of the microphone, user muting of the speaker, and the like. Conversely, audio signal flow check includes a focus on audio volume abnormalities such as frozen volume, no recording volume, no playback volume and the like. Lastly, network transmission check includes a focus on packet transmission abnormalities and decoding abnormalities, such as disconnect events, excessive packet loss and the like. These checks will be described in greater detail below in conjunction with the flowcharts of FIGS. 2-4. Once the root cause of an issue is identified, the diagnosis system will provide the relevant information for the user to self-check and fix the issue. Alternatively, the system will report an unknown reason for the issue and trigger a further investigation into the audio anomaly.

FIGS. 2A and 2B provides a flow diagram for the example process of uplink diagnosis of device operational issues, network issues and audio signal flow issues, shown generally at 200A and 200B, respectively. In this flow diagram, there are three primary components, the initial observation of a potential issue, an analysis step to refine the observation, and lastly a diagnosis based upon the observation and/or analysis. In this example process, initially a check is made if there is no recording thread present (at 201). When this is true, it may be because of a variety of reasons, such as incorrect permissions or issues with the Audio Device Manager (ADM). Thus, the system performs some additional analysis, including first checking if recording permissions are present. If there are no recording permissions, there isn't an error per se with the system. In fact, the system is operating as expected and normally given the configurations. To the user, however, they do not care if the system is operating as it should, they are just upset that their conversation is not occurring properly. As such, even though the system is operating as expected, the system will still flag the condition as an expected 209 issue based upon the lack of permissions.

If permissions are present, however, a second check may be made if the recording has been interrupted, at 205. Recording interruption may be indicative of an ADM error, and when this condition is identified, the system may result in an error flag that the ADM is experiencing an error, at 211. Likewise, if there is no recording interruption, the system may determine if the ADM is otherwise occupied, at 207. Being occupied means that the audio device (such as the microphone) is being utilized by another application, which may be expected, or due to system issues that after use or reconfiguration by another application, the status of the ADM is corrupted. If so, the same ADM error may be flagged, at 211. If there is no recording thread, and the ADM is not occupied, the analysis is exhausted and the system may result in an unknown error type, at 213.

If the system is not experiencing a no recording thread, the next observation made by the system is if the recording frequency is invalid, at 215. ADM recording frequency is calculated based on the number of system recording thread callback given a fixed time duration (e.g., every two seconds). For iOS and Android devices, the frequency of system recording callbacks may be 100 (every 10 ms). However, in RTC, the normal processing of audio frames occurs every 20 ms. As such the expected value of the ADM recording frequency is renormalize to 50. Slight variations from this number (e.g., 48-52) are common. However, significant variation from this range is indicative of a recording issue and may negatively impact the call/communication pipeline. If there is an invalid recording frequency found, the system may analyze if there is a system overload, at 217. System overloads may occur when the computing resources of the device are stretched beyond their normal capacity. To resolve this issue the device may need to have applications closed or even a device restart. When the system is determined to be overloaded, at 217, the system may flag the error as a system overload error, at 221. Otherwise, if there are no indications that the system is overloaded, but there are still invalid recording frequencies, the system may identify an unknown error, at 219.

If the recording frequencies are within normal ranges, however, the next observation is if the microphone is muted, at 223. Again, microphone muting is something the user may have inadvertently done, and is not an error in the system, but to the user they only care that the system is recording and transmitting properly. Thus, to the user, a muted microphone is as problematic as any other system error. When the system identifies that the microphone is muted, the system may flag this expected result as a problem that requires redress, at 225.

The next detection on the uplink device is if the near-in signal is frozen or not (at 227). The near-in signal is the digital signal recorded through the device microphone/recorder. As recorded audio data is framed at 20 ms intervals in real-time processing, the system may calculate the average audio signal energy given any fixed time interval (e.g., every two seconds). In the case here the ADM recording frequency is normal (e.g., 50) the microphone is not muted by an API or user behavior, then the average recording signal volume for a long period of time (e.g., 30 seconds) should not always be a fixed value, especially when the audio signal is picked up from the ambient environment. In such cases the signal should contain a certain level of randomness and show fluctuations in values. Near-in freeze may be determined by the recorded data being all zero. This may trigger an additional detection to determine the root cause of the near in freeze. Again, the system may query if there are recording permissions present, at 229. Like before, recording permissions not being present isn't an error, but it causes an issue with the intended call by the user. Thus, when recording permissions are not present, the system may flag the problem as expected, at 237. If recording permissions are present, however, the next analysis step is to determine if a recording started in the background, at 231. Again, when this occurs the system behavior is expected, and an expected flag is generated, at 237. However, when there is no recording starting in the background, a check is made if the recording is occupied (e.g., an application running in the background that may temporarily disable the recording permission by the system administrator thread), at 233. When the recording is occupied, as previously discussed, the system may flag the problem as an expected result of the system's operation, at 237. Finally, a check is made if the ADM is operating in the background, at 235. If so, the same expected problem flag may be generated, at 237. If not, then the system has exhausted its analytical checks for a frozen near-in signal, and an unknown error is generated, at 239.

If the near-in signal is not frozen, however, the next observation is whether the near-out signal may be frozen, which is detected at the next step of the uplink diagnosis (at 241). The near-out signal is the signal after various uplink audio processing modules have operated upon it. In contrast, the near-in signal is the raw signal captured through the microphone. In this example, the near-out being “frozen” means that after a series of audio processing modules, the volume of the signal does not change within a long period of time. This check occurs after the near-in signal has been determined to be normal, meaning that there are audio energy fluctuations at the near-in stage. An error at this check indicates that the fluctuations no longer exist at the near-out stage. This signal energy change can be the result of expected behavior of certain audio processing algorithms (e.g., noise suppression, pitch smoother, etc.), at 243. If an audio processing module (APM) is enabled, the near-out being frozen may be an expected result of the APM operation. As such an expected problem flag is generated, at 247. However, if algorithmic factors have already been considered and the issue still exists then the unexpected behavior is flagged as an abnormality unknown error, at 245. The pitch smoother (PS) is just one example of an audio processing module, and the invention may query if other such modules that may impact the near-out signal are enabled in a similar manner.

Turning now to FIG. 2B, for the second portion of the uplink diagnosis, the next diagnosis check is whether the recorded signal volume is adjusted to zero (at 249). This check is specific to the RTC volume adjustment API design where the user/API integrator may exercise certain volume control API to adjust the signal energy to a designated level. For example, API integrators may decide to set the volume adjustment API to zero to mute near-out signals before sending it to a specific need. If the recorded signal volume is set to zero, this is again an expected system operation and an expected problem flag is generated, at 251. Subsequently, a mute local check is performed (at 253). A mute local means that the system stops sending the local audio stream to the channel. This is controlled by RTC audio stream management APIs, and may be detected by checking if certain APIs are activated. If the system stops sending an audio stream, this is again an expected result that from the user's perspective is causing an issue with the call. Thus, an expected flag is generated for this situation, at 255.

Lastly a check is made if there is a low send bitrate (at 257). If so, a check is made if the Discontinuous Transmission (DTX) is enabled and the transmitting bitrate is greater than zero (at 259). DTX is an operating mode of audio/speech codec that reduces the sending bitrate when no active audio/speech content is detected. When DTX mode is enabled and if there is no active speech content then the sending/transmitting bitrate will drop from approximately 20 kb/s and above to less than 5 kb/s (but above zero). If the sending bitrate is below a threshold, and the DTX mode is enabled, then this behavior is expected, and an expected flag is generated, at 265. However, if the DTX mode is not enabled, there should not be a significant drop in the sending bitrate. If so, then a check is made if the connection was lost, at 261. If so a network error is generated, at 267. If the connection is not lost, a check may be made if the network is poor, at 263, in which case the same network error may be generated, at 267. If the network is fine, but there is a low send bitrate, the system may generate an unknown error, at 269.

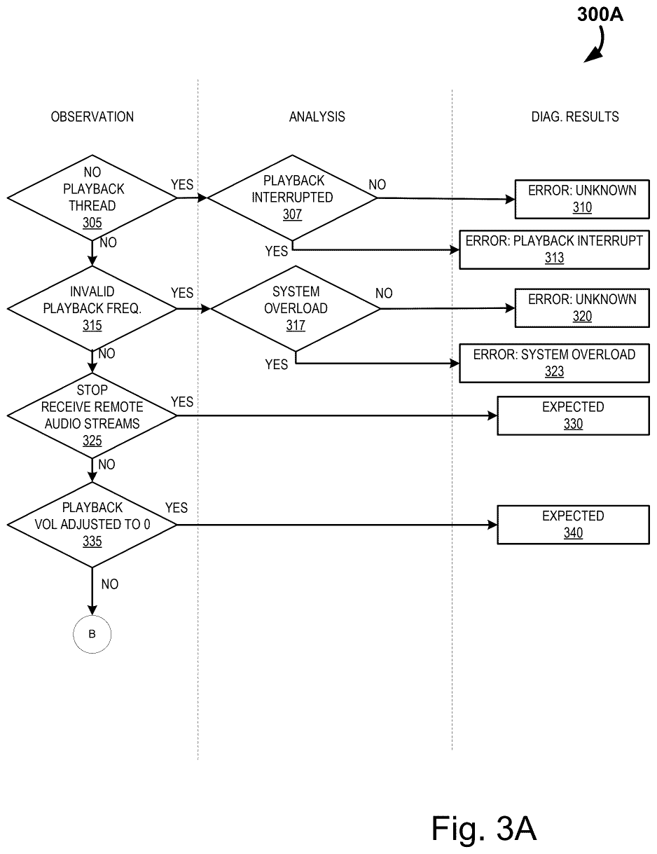

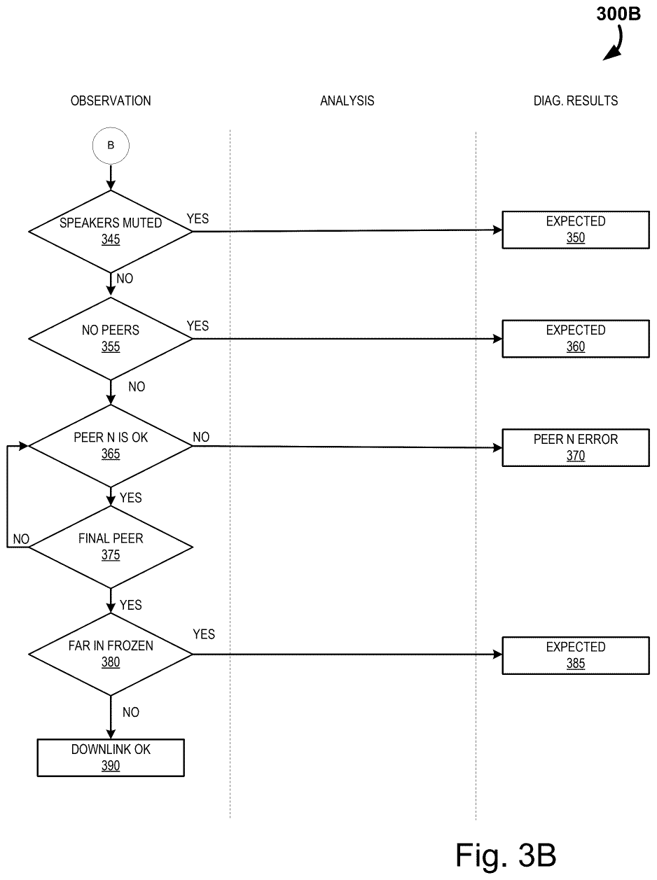

Lastly, if there isn't an issue with the bitrate, the uplink check concludes with a no reason (at 271) for the audio abnormality (e.g., the uplink is operating normally). Next the downlink check is performed, as will be discussed in greater detail below in relation to FIGS. 3A and 3B. In FIG. 3A, the first half of the process is shown generally at 300A. Again, we see the analysis as performed as an initial observation, followed by a diagnosis or additional analysis leading to the diagnosis. In this example process, again a check is made if there is no playback thread present (at 305). Unlike the uplink side, there is no permission required for the playback thread. Thus, if there is no playback thread, then a check is made if the playback was interrupted, at 307. If the playback was interrupted, then an error for playback interrupted is generated, at 313. If not, then an unknown error may be generated, at 310.

Next a check is made if the playback frequency is valid, at 315. Specifically, here the ADM playback frequency is checked. When joining an RTC channel, the playback frequency should always be the expected value. In certain cases where the playback frequency is abnormal the system normally will get an error indicating the possible reason. The calculation of playback frequency is similar to the process used to check recording frequency as described in substantial detail previously. If the playback frequency is out of range, a check if the system is overloaded is performed, at 317. If the system is found to be overloaded, the system will generate a system overload error, at 323. However, if the playback frequency is invalid, and the system is not overloaded, the system may send an unknown error, at 320.

Subsequently, a check is made if the remote peers are muted (at 325). This is when the system stops receiving remote audio streams. Remote peers are the audio streams the receiver receives. For example, if A, B and C are in the RTC channel, and A and B are both sending audio to the channel, and C is receiving the audio from both A and B, then, from C's perspective, A and B are both its remote peers. A typical RTC receiver audio stream subscription control API allows C to decide to choose the audio stream it wants, versus the audio stream it does not want to receive. C may exercise what is known as ‘mute remote’ API to disable the unwanted streams. If so, an expected flag is generated (at 330). Next, a check is made if the playback signal volume is adjusted to zero (at 335). If so, then again the system is operating as expected, but in a way that interferes with the call. As such, an expected flag is generated, at 340. Similar to recording signal volume, described previously, playback signal volume is also controlled by APIs that the user may adjust based upon their needs and desires.

This example process continues on FIG. 3B, shown generally at 300B. The next check is to determine if the speaker is muted (at 345). Again, a muted speaker is operating as it should, and is therefore not a system error, but it interferes with the call. Thus, an expected flag is generated, at 350. The next check is whether there are peers present (at 355). If not, then a no peers error is generated (at 360). No peers occurs when there is only one entity in the channel, and thus not receiving audio streams. This may happen when the other peers are offline. This information may be known from the RTC peer management module.

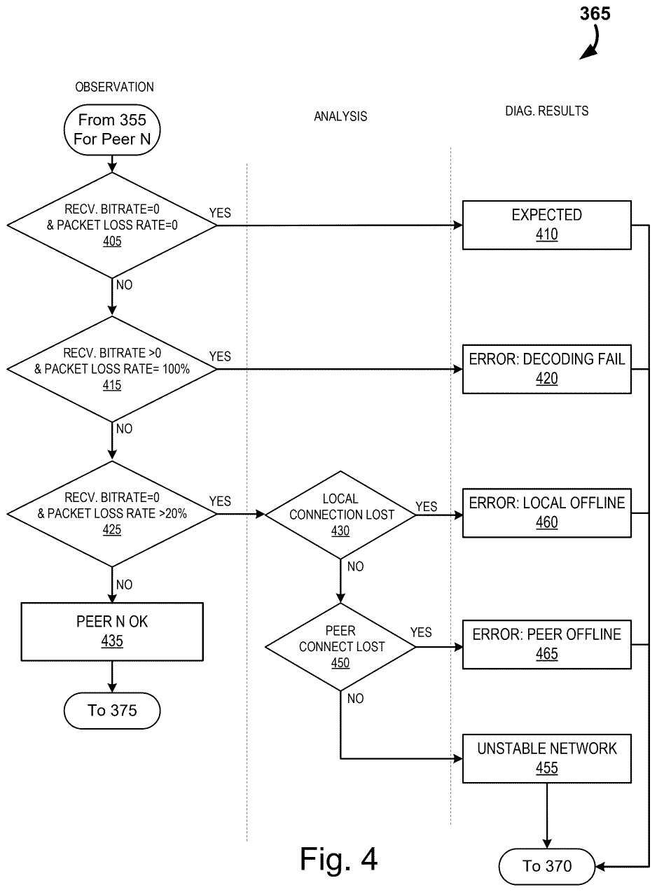

Next, a determination is made if each of the peers (1 through N) are ok, at 365. FIG. 4 provides a more detailed example of this sub-process of determining if the peer is ok or not. This sub process is repeated for each peer 1 through N where N is the final peer present. Again, it is seen that the process includes an observation followed by a diagnosis or additional analysis prior to the diagnosis. The system accesses the information (e.g., online/offline status, audio stream bitrates, and audio energies) from each peer to determine if there are any abnormalities for any given peer. Particularly, the system first determines if the received bitrate is equal to zero and the packet loss rate is equal to zero, at 405. In RTC, the server may have the capability to determine whether certain groups of audio streams are to be forwarded to the receiver side. For example, if several audio streams have low energy, the server may not desire to forward such streams in the interest of conserving bandwidth. If so, this is indicative of an expected condition, and an expected flag is generated, at 410.

Next a determination if the bitrate is greater than zero and the packet loss rate is 100% is made, at 415. When this occurs it is indicative of a decoding problem, and the system will generate an error for a decoding failure, at 420. If this is not the case, the system will check if the received bitrate is zero and the packet loss rate is more than 20% (or some other configured threshold), at 425. When this is the case, additional analysis is performed, including determining if the local connection is lost, at 430. If so, then the system generates an error for the local being offline, at 460. If the local connection is not lost, then a check is made if the peer connection was lost, at 450. If so, the system generates an error that the peer is offline, at 465. If the peer connection is not lost, then this means the network itself is unstable, and an unstable network error is generated, at 455. If however, the receiving bitrate is not equal to zero and the packet loss rate is below the threshold, then the given peer being analyzed is determined to be ok, at 435. The process then returns to step 375 of FIG. 3, where a determination is made if the peer last analyzed was the final peer. If not, the system increments the peer number and repeats step 365 for the subsequent peer. This continues until all peers are properly analyzed.

After the final peer is analyzed, the system determines if the far-in signal is frozen (e.g., the decoded far-in audio signal is zero for a long period of time). If the decoded far-in signal is all zero, that indicates the signal itself is indeed all zeros values, and it can only happen if the sender side modified the audio signal to be all zeros for certain reasons, which would be an expected behavior, and an expected flag is generated, at 385. If the far-in signal is not frozen, a downlink ok determination is made as there isn't any error detected (at 390).

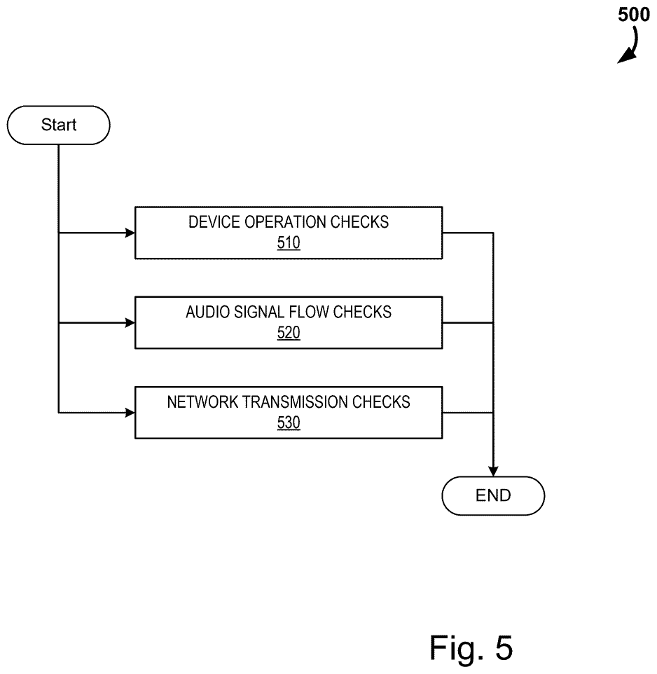

The foregoing discussion has focused on the checks as they are performed along the actual audio pipeline. Attention now will be focused on the logical subdivision of the anomaly detection. In particular, FIG. 5 provides a logical process of anomaly detection, shown generally at 500. This anomaly detection process is divided into three logically independent sub-processes: device operation check (at 510), audio signal flow check (at 520) and network transmission check (at 530). These described checks have already been discussed in considerable detail above, however, in a different order. For example, the audio signal flow checks are lumped together as they are logically related to one another, however, they may occur in the uplink device and the downlink device. Thus, while audio signal flow check is described together as a group, the location and timing of the individual checks within this larger sub-category may vary considerably.

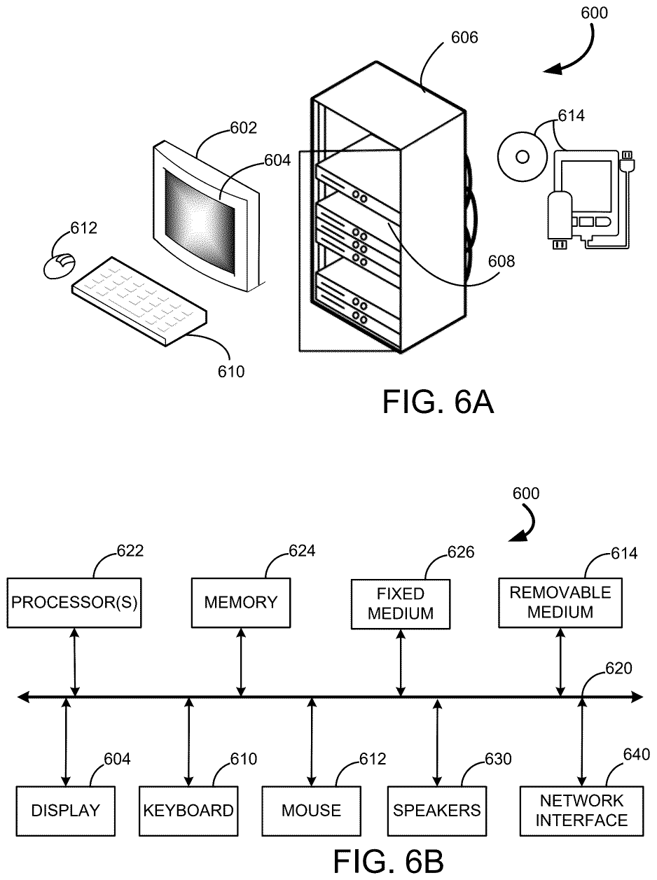

Now that the systems and methods for uplink and downlink audio abnormality detection have been provided, attention shall now be focused upon apparatuses capable of executing the above functions in real-time. To facilitate this discussion, FIGS. 6A and 6B illustrate a Computer System 600, which is suitable for implementing embodiments of the present invention. FIG. 6A shows one possible physical form of the Computer System 600. Of course, the Computer System 600 may have many physical forms ranging from a printed circuit board, an integrated circuit, and a small handheld device up to a huge supercomputer. Computer system 600 may include a Monitor 602, a Display 604, a Housing 606, server blades including one or more storage Drives 608, a Keyboard 610, and a Mouse 612. Medium 614 is a computer-readable medium used to transfer data to and from Computer System 600. FIG. 6B is an example of a block diagram for Computer System 600. Attached to System Bus 620 are a wide variety of subsystems. Processor(s) 622 (also referred to as central processing units, or CPUs) are coupled to storage devices, including Memory 624. Memory 624 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable form of the computer-readable media described below. A Fixed Medium 626 may also be coupled bi-directionally to the Processor 622; it provides additional data storage capacity and may also include any of the computer-readable media described below. Fixed Medium 626 may be used to store programs, data, and the like and is typically a secondary storage medium (such as a hard disk) that is slower than primary storage. It will be appreciated that the information retained within Fixed Medium 626 may, in appropriate cases, be incorporated in standard fashion as virtual memory in Memory 624. Removable Medium 614 may take the form of any of the computer-readable media described below.

Processor 622 is also coupled to a variety of input/output devices, such as Display 604, Keyboard 610, Mouse 612 and Speakers 630. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 622 optionally may be coupled to another computer or telecommunications network using Network Interface 640. With such a Network Interface 640, it is contemplated that the Processor 622 might receive information from the network, or might output information to the network in the course of performing the above-described audio anomaly detection methods. Furthermore, method embodiments of the present invention may execute solely upon Processor 622 or may execute over a network such as the Internet in conjunction with a remote CPU that shares a portion of the processing.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this disclosure. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

In operation, the computer system 600 can be controlled by operating system software that includes a file management system, such as a medium operating system. One example of operating system software with associated file management system software is the family of operating systems known as Windows® from Microsoft Corporation of Redmond, Washington, and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is, here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The algorithms and displays presented herein are not inherently related to any particular computer or other apparatus. Various general-purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may, thus, be implemented using a variety of programming languages.

In alternative embodiments, the machine operates as a standalone device or may be connected (e.g., networked) to other machines. In a networked deployment, the machine may operate in the capacity of a server or a client machine in a client-server network environment or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, Glasses with a processor, Headphones with a processor, Virtual Reality devices, a processor, distributed processors working together, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure may be implemented as part of an operating system or a specific application, component, program, object, module or sequence of instructions referred to as “computer programs.” The computer programs typically comprise one or more instructions set at various times in various memory and storage devices in a computer (or distributed across computers), and when read and executed by one or more processing units or processors in a computer (or across computers), cause the computer(s) to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A computerized method for uplink and downlink audio abnormality detection comprising:
at an uplink device, diagnosing audio issues at each major stage of an audio uplink pipeline in an ordered fashion;
at a downlink device, diagnosing the audio issues by combining abnormality monitoring from packet handling and decoding;
wherein the diagnosing the audio issues triggers three independent check paths; and
identifying a root cause via the diagnosing the audio issues.

2. The method of claim 1, further comprising providing information to a user to fix the audio issues, wherein the information is responsive to the root cause.

3. The method of claim 1, wherein the three independent check paths include a device operation check, an audio signal flow check and a network transmission check.

4. The method of claim 3, wherein an uplink audio check includes an ADM recording frequency check, a muted microphone check, a near-in signal frozen check, a near-out signal frozen check, a recording signal volume adjustment check, an audio stream send enabled check, and a low send bitrate check.

5. The method of claim 4, wherein the near-out signal frozen check includes at least one audio processing modules enabled check.

6. The method of claim 4, wherein the low send bitrate check includes a Discontinuous Transmission (DTX) enabled and transmitting bitrate above zero check.

7. The method of claim 3, wherein a downlink audio includes an ADM playback frequency check, a muted remote peers check, a playback signal volume adjustment check, a speaker muted check, a no peers check, a peer analyzer check and a far-in signal frozen check.

8. The method of claim 7, wherein the peer analyzer check includes performing a peer state analysis.

9. The method of claim 7, wherein the network peer analyzer includes a check if the receiving bitrate is zero and audio loss rate is zero, a check in the receiving bitrate is greater than zero and the audio loss rate is 100%, and a check if the receiving bitrate is zero and the audio loss rate is greater than a threshold.

10. The method of claim 9, wherein the threshold is 20%.

11. A computerized system for uplink and downlink audio abnormality detection comprising:
an uplink device configured to diagnose audio issues at each major stage of an audio uplink pipeline in an ordered fashion;
a downlink device configured to diagnose the audio issues by combining abnormality monitoring from packet handling and decoding;
wherein the diagnosing the audio issues triggers three independent check paths; and
a detection module configured to identify a root cause via the diagnosing the audio issues.

12. The system of claim 11, wherein the detection module is further configured to provide information to a user to fix the audio issues, wherein the information is responsive to the root cause.

13. The system of claim 11, wherein the three independent check paths include a device operation check, an audio signal flow check and a network transmission check.

14. The system of claim 13, wherein an uplink audio check includes an ADM recording frequency check, a muted microphone check, a near-in signal frozen check, a near-out signal frozen check, a recording signal volume adjustment check, an audio stream send enabled check, and a low send bitrate check.

15. The system of claim 14, wherein the near-out signal frozen check includes at least one audio processing modules enabled check.

16. The system of claim 14, wherein the low send bitrate check includes a Discontinuous Transmission (DTX) enabled and transmitting bitrate above zero check.

17. The system of claim 13, wherein a downlink audio check includes an ADM playback frequency check, a muted remote peers check, a playback signal volume adjustment check, a speaker muted check, a no peers check, a peer analyzer check and a far-in signal frozen check.

18. The system of claim 17, wherein the peer analyzer check includes performing a peer state analysis.

19. The system of claim 17, wherein the peer analyzer check includes a check if the receiving bitrate is zero and audio loss rate is zero, a check in the receiving bitrate is greater than zero and the audio loss rate is 100%, and a check if the receiving bitrate is zero and the audio loss rate is greater than a threshold.

20. The system of claim 19, wherein the threshold is 20%.
